(19) United States
(12) Patent Application Publication
(10) Pub. No.: US 2014/0274068 A1
(43) Pub. Date: Sep. 18, 2014

(54) MOBILE TERMINAL AND METHOD FOR DETERMINING A RECEIVE WINDOW

(71) Applicants: Herbert Dawid, Herzogenrath (DE); Roland Hellfajer, Bochum (DE); Frank Budke, Krefeld (DE); Alper Ceylan, Essen (DE); Frank Huertgen, Krefeld (DE); Peter Ascheuer, Duesseldorf (DE); Georg Diernhofer, Wien (AT)

(72) Inventors: Herbert Dawid, Herzogenrath (DE); Roland Hellfajer, Bochum (DE); Frank Budke, Krefeld (DE); Alper Ceylan, Essen (DE); Frank Huertgen, Krefeld (DE); Peter Ascheuer, Duesseldorf (DE); Georg Diernhofer, Wien (AT)

(21) Appl. No.: 13/834,924

(22) Filed: Mar. 15, 2013

(51) Int. Cl. H04W 36/02

(52) U.S. Cl. CPC H04W 36/02
USPC 455/442

(57) ABSTRACT

A mobile terminal is described comprising a transceiver configured to establish, for each of a plurality of radio cells, a radio link to a base station operating the radio cell; a determiner configured to determine, for each radio cell, a timing of a downlink signal transmitted from the base station operating the radio cell to the mobile terminal and configured to determine, based on the timings, a timing for a receive window in which the transceiver is to buffer signal samples received via the radio cells and a controller configured to control the transceiver to buffer signal samples received via the radio cells during the receive window.

### TECHNICAL FIELD

The present disclosure relates to mobile terminals and methods for determining a receive window.

### BACKGROUND

In a soft handover scenario, a mobile terminal has a radio link via a plurality of radio cells. Data communication between the mobile terminal via the radio cells is carried out in accordance with a unique uplink (UL) transmission timing and different downlink (DL) receive timings for the different radio cells. The reference point for all timings in the terminal is the antenna connector of the terminal. The receive timings for the radio cells may be different and may change over time when the mobile terminal moves. Efficient approaches to address this issue are desirable.

### SUMMARY

A mobile terminal is provided including a transceiver configured to establish, for each of a plurality of radio cells, a radio link to a base station operating the radio cell; a determiner configured to determine, for each radio cell, a timing of a downlink signal transmitted from the base station operating the radio cell to the mobile terminal and configured to determine, based on the timings, a timing for a receive window in which the transceiver is to buffer signal samples received via the radio cells and a controller configured to control the transceiver to buffer signal samples received via the radio cells during the receive window.

Further, a method for determining a receive window according to the mobile terminal described above is provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a mobile radio communication system according to UMTS.

FIG. 2 shows a mobile radio communication system in soft handover state.

FIG. 3 shows timing diagrams.

FIG. 4 shows a mobile terminal.

FIG. 5 shows a flow diagram.

FIG. 6 shows a mobile radio communication system for illustration of the determining of a receive window.

### DESCRIPTION

The following detailed description refers to the accompanying drawings that show, by way of illustration, specific details and aspects of this disclosure in which the invention may be practiced. These aspects of this disclosure are described in sufficient detail to enable those skilled in the art to practice the invention. Other aspects of this disclosure may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

FIG. 1 shows a mobile radio communication system 100 which is, in this example, based on the UMTS communication standard according to 3GPP (Third Generation Partnership Project).

A mobile radio network 131 in the mobile radio communication system 100 has the architecture of a UMTS radio network, which is also called a UMTS terrestrial radio access network (UTRAN).

The mobile radio communication system 100 has a plurality of mobile radio network subsystems (RNS) 101, 102 which are each coupled to the UMTS core network 105 by means of an Iu interface 103, 104.

The UMTS core network 105 has a circuit-switched (CS) domain 132, a packet-switched (PS) domain 133 and a home location register (HLR) 134.

The CS domain 132 includes the components MSC (Mobile Switching Center), GMSC (Gateway Mobile Switching Center), VLR (Visitor Location Register) and forms the interface for circuit-switched connections between the mobile radio network 131 and external public networks such as the PSTN (Public Switch Telephone Network) or the ISDN (Integrated Services Digital Network).

The CS domain 132 performs all the necessary functions to ensure transport of circuit-switched connection data between the PSTN or the ISDN and a mobile radio user terminal 106.

The PS domain 133 includes the components SGSN (Serving GPRS Support Node), GGSN (Gateway GPRS Support Node) and forms the interface for packet-switched connections between the mobile radio network 131 and external packet-based data networks, such as the Internet.

Accordingly, the PS domain 133 performs all of the functions to ensure transport of packet-switched data between external packet networks and the mobile radio user terminal 106.

The HLR 134 is a central database storing all of the information from users which is necessary, inter alia, for setting up connections and for routing services.

The RNSs 101, 102 each have a mobile radio network control unit (radio network controller, RNC) 107, 108 and one or more mobile radio base stations 109, 110, 111, 112.

A UMTS base station is also called NodeB.

The RNCs 107, 108 of different RNSs 101, 102 are coupled to one another by means of an Iur interface 113. Each mobile radio base station 109, 110, 111, 112 of an RNS 101, 102 is coupled to the RNC 107, 108 of the RNS 101, 102 by means of an Iub interface. In addition, each mobile radio base station 109, 110, 111, 112 of an RNS 101, 102 operates one or more radio cells (CE) 114 to 125 within the RNS 101, 102 for radio purposes. The RNC 107, 108 of an RNS 101, 102 monitors the association between radio resources in the radio cells 114 to 125 in the RNS 101, 102.

The entire geographical area in which data can be transmitted using the mobile radio communication system 100 and using the mobile radio user terminal 106 is divided into the radio cells 114 to 125.

When data are transmitted in a radio cell 114 to 125 using the mobile radio user terminal 106, the data are transmitted using the mobile radio base station 109, 110, 111, 112 which operates this radio cell 114 to 125. Between a mobile radio base station 109, 110, 111, 112 and the mobile radio user terminal (user equipment UE) 106, for example a mobile radio, in a radio cell 114 to 125, message signals and data signals are transmitted using an air interface (Uu) 130, preferably using a multiple access transmission method.

By way of example, separate signal transmission in the uplink and in the downlink is achieved in the UMTS's FDD (Frequency Division Duplex) mode through appropriate separate allocation of frequencies or frequency ranges.

Uplink is to be understood to mean the signal transmission from a mobile radio user terminal 106 to a mobile radio base station 109, 110, 111, 112, and downlink is to be understood to mean the signal transmission from a mobile radio base station 109, 110, 111, 112 to a mobile radio user terminal 106. The signals to different mobile radio user terminals and from different mobile radio user terminals in the same radio cell are preferably separated by means of orthogonal codes, for example using the “CDMA” (Code Division Multiple Access) method.

A user may move with his user terminal 106 through the coverage area of the communication system 100 and move between the radio cells 114 to 125. For this, the communication system 100 provides a handover mechanism. Handover is understood to mean the process in which the user terminal 106 is passed on from the coverage area of one radio cell 114 to 125 to the coverage area of a new radio cell 114 to 125 while there is a communication to the network side of the communication system 100 that is to say that the radio cell to which the user terminal has a radio link for providing the communication connection (such as a call or a data connection) changes.

A soft handover is a special handover, in the course of which a user terminal has a respective dedicated radio link with a plurality of radio cells simultaneously. This is illustrated in FIG. 2.

FIG. 2 shows a mobile radio communication system 200.

The mobile radio communication system 200 shown is of similar design as the mobile radio communication system 100 shown in FIG. 1 including RNCs 211, 212, base stations 208, 209, 210, radio cells 202 to 207 and a mobile terminal 201 as described with reference to FIG. 1.

In this example, the mobile terminal 201 is in a soft handover state, i.e. the mobile radio user terminal 201 has a plurality of dedicated radio links to different radio cells simultaneously: a first dedicated radio link 213 to the first radio cell 202, a second dedicated radio link 214 to the second radio cell 203, a third dedicated radio link 215 to the third radio cell 204, a fourth dedicated radio link 216 to the fourth radio cell 205, a fifth dedicated radio link 217 to the fifth radio cell 206, and a sixth dedicated radio link 218 to the sixth radio cell 207. The dedicated radio links 213 to 218 are for example DPCH (Dedicated Physical Channel) or F-DPCH (Fractional Dedicated Physical Channel) radio links (RLs).

This situation may for example arise on the basis of the UMTS-FDD (Frequency Division Duplex) mode, where a mobile radio user terminal can have a dedicated radio link to a maximum of six radio cells simultaneously. A soft handover may for example be entered for the mobile terminal 201 when the reception quality of all the radio cells 202 to 207 is bad (e.g. when it is located at the edge of the radio cells 202 to 207) to increase the overall performance of the communication connection by making use of transmission diversity.

According to 3GPP, to provide soft handover (SHO) to work, strict requirements are defined for the timing of the involved radio cells 202 to 207 in SHO for transmission and reception of DPCH or F-DPCH radio links (RLs) 213 to 218. The timings of the radio cells 202 to 207 may be asynchronous. According to 3GPP, the network may set up the timing of the downlink DPCH or F-DPCH RLs with a granularity of 256 chips by setting the so called DPCH frame offset parameter accordingly. Hence the network may set up the timing of the downlink DPCH or F-DPCH RLs such that they arrive at the UE antenna connector within a receive window of T₀±148 chips (wherein To is equal to 1024 chips) prior to the frame timing of the uplink DPCCH/DPDCH at the UE 201. At the mobile terminal (also referred to as UE in the following according to UMTS), the uplink DPCCH/DPDCH (Dedicated Physical Control Channel/Dedicated Physical Data Channel) frame transmission has, according to 3GPP, to take place 1024 chips after the reception of the first significant detected path (in time) of the corresponding downlink DPCH or F-DPCH frame. When communication connection is established (e.g. a call is started) the uplink timing is set accordingly by the UE 201.

Besides potential timing drifts of the paths received from the initial cell (i.e. the first radio cell to which the UE 201 established a radio link when the communication connection was established) due to the UE movement, this initial cell may eventually be removed from the active set (AS), i.e. the set of radio cells 202 to 207 involved in SHO. As long as the AS contains more than one cell, the further maintenance of the uplink and downlink timing by the UE is not defined by 3GPP. When the AS contains just a single cell, the UE must re-establish the UL-DL timing difference or relation of 1024 chips according to 3GPP as explained below. This is illustrated in FIG. 3.

FIG. 3 shows timing diagrams 301, 302.

In the first timing diagram 301, the DL timing 303 of a first cell is indicated. N/2 chips after the DL timing 303 of the first cell, wherein N is the length of the receive window, the UE the DL processing timing 304 is set. The UL timinig 305 is set by the UE to be 1024 chips after the DL timing 303.

The second timing diagram 302 illustrates the scenario when a second cell and a third cell have entered the active set of the UE. DL timing 303 of the first cell, DL processing timing 304 and UL timing are still set according by the first cell. The DL timing 306 of the second cell and the DL timing 307 of the third cell fall within the receive window, i.e. within ±148 chips of the DL timing 303 of the first cell.

According to 3GPP, the uplink (UL) timing must not jump, i.e., when the UE 201 wants to change the timing, it must be adjusted slowly by an intentional drift initiated by the UE 201 with a maximum allowed rate of ¼ chip every 200 ms (called “transmission timing adjustment” in 3GPP). When a radio cell 202 to 207 is added to the active set and a new radio link 213 to 218 is established via this radio cell 202 to 207, the network side starts transmission of the downlink DPCH or F-DPCH for the new radio link at a frame timing such that the frame timing received at the UE 201 is within a receive window of T₀±148 chips (wherein T₀ is equal to 1024 chips) prior to the frame timing of the uplink DPCCH/DPDCH at the UE 201. To be able to make use of the transmission diversity provided by the soft handover, the receive window introduces a requirement for the amount of received samples the UE 201 is required to buffer, since the UE 201 needs to compensate for this residual delay difference. For example, the UE 201 may need to buffer a sample received from one of the radio cells 202 to 207 until it has received a corresponding sample from another of the radio cells 202 to 207 to be able to combine these samples to make use of the transmission diversity.

During movement of the UE 201, the downlink (DL) timing of the received radio links 213 to 218 typically changes constantly. According to 3GPP, a number of reporting events are defined in order to cope with the situation that the downlink timing of a radio link moves out of the receive window:
Reporting event 6F (FDD): The UE Rx-Tx (Receive-Transmit) time difference for a radio cell included in the active set becomes larger than an absolute threshold
Reporting event 6G: The UE Rx-Tx time difference for a radio cell included in the active set becomes less than an absolute threshold

3GPP also defines measurements for the UE Rx-Tx timing difference type 1 which is the difference in time between the UE uplink DPCCH frame transmission and the first detected path (in time), of the downlink DPCH or F-DPCH frame from the measured radio link, whereas the reference Rx path shall be the first detected path (in time) amongst the paths (from the measured radio link) used in the demodulation process. UE Rx-Tx timing difference type 1 measurements will be performed for every radiolink in the active set.

In case of event 6F or 6G, the network side (i.e. for example a component of the radio access network including base stations 208, 209, 210 and RNCs 211, 212) may detect the critical radio link from these UE Rx-Tx timing difference measurements and adjust the timing of the critical radio link accordingly by +/−256 chips, corresponding to a physical layer reconfiguration without interruption of the transmission of the critical radio link. However, a communication network may not use this processing, and the radio cell corresponding to a radio link may simply be removed from the active set (AS) in case that the radio link's receive timing falls outside the receive window. Even if the respective radio link is set up later again with changed timing by the network, this corresponds to an interruption of the transmission of this radio link.

In the following, a communication terminal is described that may avoid that a radio cell is removed from an active set due to its timing falling out of the communication terminal's receive window.

FIG. 4 shows a mobile terminal 400.

The mobile terminal 400 includes a transceiver 401 configured to establish, for each of a plurality of radio cells, a radio link to a base station operating the radio cell.

The mobile terminal 400 further includes a determiner 402 configured to determine, for each radio cell, the timing of a downlink signal transmitted from the base station operating the radio cell to the mobile terminal and configured to determine, based on the timings, a timing for a receive window in which the transceiver is to buffer signal samples received via the radio cells.

Further, the mobile terminal 400 includes a controller 403 configured to control the transceiver to buffer signal samples received via the radio cells during the receive window.

In other words, a mobile terminal in soft handover determines a receive window timing, or, in other words, a downlink reference timing, based on the downlink timings of the radio cells involved in the soft handover.

For example, since 3GPP does not specify the maintenance of the uplink and downlink timing in soft handover in case the initial radio cell used for setting up a communication connection is removed from the active set and the AS size is still larger than 1, a mobile terminal may choose a timing reference based on the timing of the radio cells remaining in the active set. This may be seen as the timing of a (possibly virtual) reference cell. The mobile terminal may, according to 3GPP, then ensure (e.g. via the intentional slow drift of ¼ chip per 200 ms mentioned above) that the uplink timing is located 1024 chips after the chosen downlink reference timing

For example, when a reference cell (e.g. the initial cell) is removed from the active set and the AS size is still larger than 1, the mobile terminal 106 may select a new downlink reference timing close to the mean of the received downlink timing of the radio cells (remaining) in the active set. Further, the mobile terminal may take into account the strength of the radio cells (e.g. the quality of the pilot signal or dedicated signal or other suitable signals received via the radio cells) or any other quality measure for determining the receive window timing.

For example, when a reference cell (e.g. the initial cell) is removed from the active set and the AS size is still larger than 1, the mobile terminal 106 may keep the timing reference according to the removed cell in order to avoid transmission timing adjustments in the uplink e.g. in order to reduce power consumption in the terminal.

For example, when a reference cell (e.g. the initial cell) is removed from the active set and the AS size is still larger than 1, the mobile terminal 106 may, in case of High-Speed DL Packet Access (HSDPA) operation, select the timing of the HSDPA serving cell as new timing reference or avoid transmission timing adjustments in the uplink.

The mobile terminal has for example a communication connection via the radio links.

For example, the determiner is configured to determine the timing for the receive window and the controller is configured to control the transceiver to buffer signal samples received via the radio cells during the receive window in response to a radio link to a base station via which the communication connection has been established, being released.

The mobile terminal may for example include a detector configured to detect the release of the radio link via which the communication connection has been established.

The radio links may for example include the radio links via which the mobile terminal has the communication connection remaining after release of the radio link via which the communication connection has been established

The determiner may further be configured to determine an uplink timing based on receive window timing and the controller may be configured to control the transceiver to transmit uplink data according to the uplink timing.

The determiner is for example configured to determine as timing for the receive window a start time and an end time of the receive window.

For example, the determiner is configured to determine the start time and an end time of the receive window based on a predetermined length of the receive window and is for example configured to determine a location of the receive window in time based on the timings.

The timing of the receive window is for example a center time of the receive window.

The determiner is for example configured to determine the timing of the receive window as an arithmetic combination of the timings.

For example, the determiner is configured to determine the timing of the receive window as a mean of the timings.

The determiner may for example be configured to determine the timing of the receive window as a weighted mean of the timings.

For example, the determiner is configured to determine a weight of a timing of a radio cell based on the reception quality of signals transmitted via the radio cell at the mobile terminal

The determiner may be configured to detect whether there is a risk that the downlink transmission timing of one of the radio cells is going to fall out of a current receive window timing and, in case the risk is detected, may be configured to determine the timing of the receive window to reduce the risk.

For example, the determiner is configured to determine the timing of the receive window by adjusting the current receive window timing.

The determiner is for example configured to determine the timing of the receive window to reduce the risk in case the risk is detected and in case that the reception quality of signals transmitted via the radio cell is above a predetermined threshold.

The controller is for example configured to adapt a current receive window timing to the determined timing for the receive window in accordance with a timing drift.

The radio links (and accordingly the mobile terminal, e.g. the transceiver, and the base stations) are for example configured according to UMTS as specified by 3GPP.

The components of the mobile terminal (e.g. the transceiver, the determiner and the controller) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit”.

The mobile terminal for example carries out a method as illustrated in FIG. 5.

FIG. 5 shows a flow diagram 500.

The flow diagram 500 illustrates a method for determining a receive window, for example carried out by a mobile terminal.

In 501, the mobile terminal establishes, for each of a plurality of radio cells, a radio link to a base station operating the radio cell, e.g. if instructed accordingly by the network.

In 502, the mobile terminal determines, for each radio cell, a timing of a downlink signal transmitted from the base station operating the radio cell to the mobile terminal.

In 503, the mobile terminal determines, based on the timings, a timing for a receive window in which to buffer signal samples received via the radio cells.

In 504, the mobile terminal buffers signal samples received via the radio cells during the receive window.

It should be noted that examples described in context of the mobile terminal 400 are analogously valid for the method illustrated in FIG. 5 and vice versa.

In the following an example for a mobile terminal determining a timing for a receive window is described in more detail.

FIG. 6 shows a mobile radio communication system 600.

Similar to the mobile radio communication system 400, the communication system 600 includes a first base station 601 operating a first radio cell, a second base station 602 operating a second radio cell, a third base station 603 operating a third radio cell and a mobile terminal 604 which has a radio link to each of the base stations 601, 602, 603, i.e. has a soft handover wherein the first radio cell, the second radio cell and the third radio cell are in the active set. The mobile terminal 604 for example has a communication connection (such as a data transfer or a call), e.g. to a server computer or another mobile terminal via the radio links to the base stations 601, 602, 603 wherein the radio links provide spatial transmission diversity to increase the quality of the communication connection. The communication system 600 is assumed to be configured according to UMTS as specified by 3GPP.

FIG. 6 further illustrates the receive window 605 used by the mobile terminal 604, i.e. the time interval for which it buffers signal samples received from the base stations 601, 602, 603 during this time. It thus represents the amount of received signal samples (e.g. baseband samples) which need to be stored by the mobile terminal 106. The timing of the received window is defined by a (downlink) reference timing 606. According to 3GPP, the receive window 605 needs to at least include +/−148 chips around the reference timing 606. The implementer may choose the receive window 605 to be larger than that.

In this example, the first base station 601 transmits to the mobile terminal 604 with a first timing and a first power delay profile 607 such that the reception of downlink signals from the first base station 601 is nearest to the timing reference 606 among the base stations 601, 602, 603.

The second base station 602 transmits to the mobile terminal 604 with a second timing and a second power delay profile 608 such that the mobile terminal 604 receives downlink signals from the second base station 602 latest among the base stations 601, 602, 603, to the right border of the receive window 605.

The third base station 603 transmits to the mobile terminal 604 with a third timing and a third power delay profile 609 such that the mobile terminal 604 receives downlink signals from the third base station 603 earliest among the base stations 601, 602, 603, to the left border of the receive window 605.

It is assumed that none of the first base station 601, the second base station 602 and the third base station 603 is the initial radio cell used by the mobile terminal 604 for the communication connection, i.e. the radio cell via which the mobile terminal 604 has established the communication connection.

The mobile terminal 604 may therefore decide about its downlink timing, i.e. the location in time of the receive window 605, and its uplink transmission timing itself (under the requirement that the downlink timing reference 606 lies 1024 chips before the uplink transmission timing). It may for example choose a reference cell of the radio cells according to which it determines its downlink and uplink timing, e.g. it may determine the downlink timing reference 606 according to the downlink timing of the chosen reference cell or it may also define a virtual reference cell not corresponding to a real cell as a reference for the downlink and uplink timing.

The mobile terminal 604 may for example move (e.g. may be located in a moving car) which leads to a changing of the timing of the downlink transmissions by the base stations 601, 602, 603 with respect to the mobile terminal 604. To ensure that no radio cell is removed from the active set due to the downlink transmission from the respective base station falling out of the receive window 605, the mobile terminal 604 may change the timing reference 606 taking the downlink timings of the base stations 601, 602, 603 into account. For example, the mobile terminal 604 may determine the mean of the downlink timings of the base stations 601, 602, 603, for example the mean of the timings of the respective first significant paths of the base stations 601, 602, 603, i.e. take for each base station 601, 602, 603 the timing of the first reception of a certain downlink transmission and determine the mean of these timings as the downlink reference timing. The mobile terminal 604 could treat this downlink reference timing as the timing of a virtual reference radio cell. After determining a downlink reference timing, the mobile terminal 604 may for example move its current uplink timing to the uplink timing according to the determined reference timing (i.e. 1024 chips after the determined downlink reference timing 606) by initiating a timing drifts of ¼ chip per 200 ms in the direction of the uplink timing according to the determined reference timing.

However, even in case the mobile terminal 604 takes the mean of the base station downlink timings as timing reference, the case may arise that the timing of one of the base stations 601, 602, 603 drifts out of the receive window 505. For example, in case the timing of the first base station 601 is nearer to the timing of the second base station 602 than to the timing of the third base station 603, the downlink timing of the third base station 603 may drift out of the receive window 605 in case that the timings of the second base station 602 and the third base station 603 drift apart.

Now, the first radio cell and the second radio cells may be weak cells, i.e. the reception quality of signals transmitted via these cells may be low such that they do not contribute significantly to the total reception quality at the mobile terminal 604 while the third radio cell is assumed to be a strong cell with a large contribution to the total reception quality at the mobile terminal 604. Therefore, the mobile terminal 604 may want to avoid that the third base station 603 drifts out of the receive window 606 and is removed from the active set.

For this, for example, the mobile terminal 604 may take into account the reception quality of the radio cells when determining the timing reference 606. In other words, the mobile terminal 604 may use a receive quality based intelligent algorithms for timing management of 3GPP active set cells in soft handover.

For example, the mobile terminal 604 may take the following quality indicators for the radio cells involved in soft handover into account:
CPICH (Common Pilot Channel) Echo or CPICH RSCP (Received Signal Code Power). These are general performance metrics for a radio cell based on the received CPICH quality (Echo in dB) or absolute signal strength (RSCP in dBm). According to 3GPP, measurement of these values is required and hence these values are available in the mobile terminal 604.
Downlink DPCH SIR (Signal to Interference Ratio). A measurement of this value may be available for an individual cell in the active set. Measurement of this value is not required by 3GPP.
other quality measures.

Based on any of these quality indicators for the radio cells (or for the radio links), the mobile terminal 604 may determine the timing reference 506.

For example, the mobile terminal 604 may determine a weighted arithmetic mean of the individual cell timings (rather than a simple arithmetic mean) wherein the weight of the timing of a radio cell depends on the quality of the radio cell. For example, for radio cell with index i, the weight factor may be given by

$$\frac{qual ( i )}{{\sum }_{i = 1}^{N} qual ( i )}$$

where N is the number of radio cells considered for determining the timing reference 606 and qual(i) is a quality measure (e.g. a linear quality measure) of the radio cell.

Assuming that the timing of the i-th radio cell is given by FSPtiming(i) (e.g. gives the time of the first significant detected path of the i-th radio cell or the first significant path used for demodulation of the signal transmitted via the i-th radio cell) the reference timing 606 is for example determined according to

$$reference timing = {\sum }_{i = 1}^{N} \frac{qual ( i )}{{\sum }_{i = 1}^{N} qual ( i )} FSPtiming ( i ) .$$

Alternatively to determining a mean or a weighted mean of the timings of the radio cells, the mobile terminal may use other approaches (e.g. “nonlinear algorithms”) to determining the timing reference 606. For example, in case that the timing of one of the base stations tends to move out of the receive window 605 (e.g. indicated e.g. by its timing exceeding some threshold) then the mobile terminal 604 may initiate an intentional timing drift in the opposite direction to keep the cell within the receive window 505. To avoid the drawbacks of the timing drift (e.g. decrease of transmission performance), the mobile terminal 604 may for example keep the timing reference 606 constant otherwise.

For example, such an approach (as well as the approach of determining a mean or weighted mean) may be used to keep the (e.g. strong) third radio cell within the receive window 605.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. Mobile terminal comprising
a transceiver configured to establish, for each of a plurality of radio cells, a radio link to a base station operating the radio cell;
a determiner configured to determine, for each radio cell, a timing of a downlink signal transmitted from the base station operating the radio cell to the mobile terminal and configured to determine, based on the timings, a timing for a receive window in which the transceiver is to buffer signal samples received via the radio cells; and
a controller configured to control the transceiver to buffer signal samples received via the radio cells during the receive window.

2. Mobile terminal according to claim 1, wherein the mobile terminal has a communication connection via the radio links.

3. Mobile terminal according to claim 2, wherein the determiner is configured to determine the timing for the receive window and the controller is configured to control the transceiver to buffer signal samples received via the radio cells during the receive window in response to a radio link to a base station via which the communication connection has been established, being released.

4. Mobile terminal according to claim 3, comprising a detector configured to detect the release of the radio link via which the communication connection has been established.

5. Mobile terminal according to claim 3, wherein the radio links comprise the radio links via which the mobile terminal has the communication connection remaining after release of the radio link via which the communication connection has been established

6. Mobile terminal according to claim 1, wherein the determiner is further configured to determine an uplink timing based on receive window timing and the controller is configured to control the transceiver to transmit uplink data according to the uplink timing.

7. Mobile terminal according to claim 1, wherein the determiner is configured to determine as timing for the receive window a start time and an end time of the receive window.

8. Mobile terminal according to claim 7, wherein the determiner is configured to determine the start time and an end time of the receive window based on a predetermined length of the receive window and is configured to determine a location of the receive window in time based on the timings.

9. Mobile terminal according to claim 1, wherein the timing of the receive window is a center time of the receive window.

10. Mobile terminal according to claim 1, wherein the determiner is configured to determine the timing of the receive window as an arithmetic combination of the timings.

11. Mobile terminal according to claim 1, wherein the determiner is configured to determine the timing of the receive window as a mean of the timings.

12. Mobile terminal according to claim 1, wherein the determiner is configured to determine the timing of the receive window as a weighted mean of the timings.

13. Mobile terminal according to claim 12, wherein the determiner is configured to determine a weight of a timing of a radio cell based on the reception quality of signals transmitted via the radio cell at the mobile terminal.

14. Mobile terminal according to claim 1, wherein the determiner is configured to detect whether there is a risk that the downlink transmission timing of one of the radio cells is going to fall out of a current receive window timing and, in case the risk is detected, is configured to determine the timing of the receive window to reduce the risk.

15. Mobile terminal according to claim 14, wherein the determiner is configured to determine the timing of the receive window by adjusting the current receive window timing.

16. Mobile terminal according to claim 14, wherein the determiner is configured to determine the timing of the receive window to reduce the risk in case the risk is detected and in case that the reception quality of signals transmitted via the radio cell is above a predetermined threshold.

17. Mobile terminal according to claim 1, wherein the controller is configured to adapt a current receive window timing to the determined timing for the receive window in accordance with a timing drift.

18. Mobile terminal according to claim 1, wherein the radio links are configured according to UMTS as specified by 3GPP.

19. Method for determining a receive window comprising
establishing, for each of a plurality of radio cells, a radio link to a base station operating the radio cell;
determining, for each radio cell, a timing of a downlink signal transmitted from the base station operating the radio cell to the mobile terminal;
determining, based on the timings, a timing for a receive window in which to buffer signal samples received via the radio cells; and
buffering signal samples received via the radio cells during the receive window.

20. Method according to claim 19, further comprising determining an uplink timing based on receive window timing and transmitting uplink data according to the uplink timing.
